(19) United States
(12) Patent Application Publication
(10) Pub. No.: US 2006/0047410 A1
(43) Pub. Date: Mar. 2, 2006

(54) Traveling control device of vehicle

(75) Inventor: Takuji Oka, Hiroshima (JP)

Correspondence Address: NIXON PEABODY, LLP, 401 9TH STREET, NW, SUITE 900, WASHINGTON, DC, 20004-2128, US

(73) Assignee: Mazda Motor Corporation, Aki-gun (JP)

(21) Appl. No.: 11/168,562

(22) Filed: Jun. 29, 2005

(30) Foreign Application Priority Data
Sep. 1, 2004 (JP) 2004-254604

(51) Int. Cl. G08G 1/00

(52) U.S. Cl. 701/117

(57) ABSTRACT

At first, it is determined whether or not the own vehicle travels in the auto-cruising mode. When the answer is YES, it is determined whether or not the traffic congestion occurs on the next lane. When the answer is YES, the steering device is controlled so as to shift the own vehicle's traveling position toward the opposite side from the next lane. Thereby, the own vehicle travels at the opposite-side sifted position at the constant speed. Accordingly, the own vehicle's crash against the cutting-into vehicle from the next lane when the traffic congestion occurs on the next lane can be properly avoided without operating the accelerator, brake, or steering handle.

### BACKGROUND OF THE INVENTION

The present invention relates a traveling control device of a vehicle.

Conventionally, a traveling control device of a vehicle, which performs on a highway or the like an auto-cruising control to adjust a vehicle speed of an own vehicle at a constant speed or a following-traveling control to adjust the own vehicle's speed so as to control a vehicle-to-vehicle distance between the own vehicle and a vehicle traveling in front of the own vehicle at a target vehicle-to-vehicle distance, is known. For example, Japanese Patent Laid-Open Publication No. 2004-38861 discloses the traveling control device of a vehicle which performs the following-traveling control, in which when a traffic congestion occurs on a traveling lane of the own vehicle, the target vehicle-to-vehicle distance is changed.

Generally, when the traffic congestion occurs on another lane next to the own vehicle's traveling lane, other vehicles traveling on the next lane sometimes cut into the traveling lane of the own vehicle to get out of the traffic congestion. Accordingly, it is preferable that the above-described traveling control device of a vehicle is constituted so as to avoid a crash against such vehicles cutting into in front of the own vehicle, without operating the accelerator, brake, or steering handle, when the traffic congestion occurs on the next lane.

### SUMMARY OF THE INVENTION

The present invention has been devised in view of the above-described problem, and an object of the present invention is to provide a traveling control device of a vehicle equipped with a vehicle speed control device operative to control the vehicle speed of the own vehicle so as to be set at a specified vehicle speed, which can properly avoid the crash against the cutting-into vehicle from the next lane, without operating the accelerator, brake, or steering handle, when the traffic congestion occurs on the next lane.

According to the present invention, there is provided a traveling control device of a vehicle comprising a vehicle speed control device operative to control a vehicle speed of an own vehicle so as to be set at a specified vehicle speed, a traveling position detecting device operative to detect a traveling position of the own vehicle on a traveling lane of the own vehicle, a traffic congestion determining device operative to determine whether a traffic congestion occurs or not on a lane which is next to the traveling lane of the own vehicle, and a shifting control device operative to shift the traveling position of the own vehicle toward an opposite side from the next lane when the vehicle speed control device performs the vehicle speed control of the own vehicle and it is determined by the traffic congestion determining device that the traffic congestion occurs on the next lane.

Accordingly, since the shifting control device performs the shifting control to shift the traveling position of the own vehicle toward the opposite side from the next lane when the vehicle speed control device performs the vehicle speed control of the own vehicle and it is determined by the traffic congestion determining device that the traffic congestion occurs on the next lane, the own vehicle is kept away from the next lane. Thus, the crash against the cutting-into vehicle from the next lane can be properly avoided without operating the accelerator, brake, or steering handle, when the vehicle speed control device controls the own vehicle's speed and the traffic congestion occurs on the next lane.

According to a preferred embodiment of the present invention, there is further provided a cutting-into probability calculating device which calculates a probability of another vehicle traveling on the next lane cutting into the traveling lane of the own vehicle when it is determined by the traffic congestion determining device that the traffic congestion occurs on the next lane, wherein the shifting control device is constituted so as to perform the shifting control based on the probability calculated by the cutting-into probability calculating device when the vehicle speed control device performs the vehicle speed control of the own vehicle and it is determined by the traffic congestion determining device that the traffic congestion occurs on the next lane.

Generally, the probability of another vehicle traveling cutting into the own vehicle's traveling lane from the next lane with the traffic congestion is considered influenced by the driver's mental state.

According to the above-described preferred embodiment, the cutting-into probability calculating device calculates the probability of another vehicle traveling on the next lane cutting into the own vehicle's traveling lane when it is determined by the traffic congestion determining device that the traffic congestion occurs on the next lane, and the shifting control device performs the shifting control based on the probability calculated by the cutting-into probability calculating device when the vehicle speed control device performs the vehicle speed control of the own vehicle and it is determined by the traffic congestion determining device that the traffic congestion occurs on the next lane. Accordingly, the shifting control device can perform the shifting control which is suitable to the driver's mental state of the vehicle traveling on the next lane with the traffic congestion.

According to another preferred embodiment of the present invention, the shifting control device is constituted so as to perform the shifting control of the own vehicle by controlling a steering device when the vehicle speed control device performs the vehicle speed control of the own vehicle and it is determined by the traffic congestion determining device that the traffic congestion occurs on the next lane.

Accordingly, an appropriate control of the shifting control device according to the present invention can be attained.

According to another preferred embodiment of the present invention, there is further provided a lane-deviation preventing device operative to prevent the own vehicle from deviating from the traveling lane of the own vehicle when the shifting control device performs the shifting control of the own vehicle by controlling the steering device.

Accordingly, since the lane-deviation preventing device prevents the own vehicle from deviating from the traveling lane of the own vehicle when the shifting control device performs the shifting control of the own vehicle by controlling the steering device, the deviation of the own vehicle from the traveling lane can be properly prevented when the shifting control device performs the shifting control.

According to another preferred embodiment of the present invention, the vehicle speed control device is constituted so as to control the own vehicle's speed at a target vehicle speed which is set as the specified vehicle speed.

Accordingly, the present invention can be properly applied to the device which performs the so-called auto-cruising control enabling the driver's non-operation of the accelerator or the brake.

According to another preferred embodiment of the present invention, the vehicle speed control device is constituted so as to control the own vehicle's speed in such a manner that a vehicle-to-vehicle distance between the own vehicle and a vehicle which travels on the same lane and in front of the own vehicle is equal to a target vehicle-to-vehicle distance.

Accordingly, the present invention can be properly applied to the device which performs the so-called following-traveling control enabling the driver's non-operation of the accelerator or the brake.

According to another preferred embodiment of the present invention, the cutting-into probability calculating device is constituted so as to calculate the probability based on a distance of the traffic congestion on the next lane.

Accordingly, an appropriate control of the cutting-into probability calculating device can be attained.

According to another preferred embodiment of the present invention, the cutting-into probability calculating device is constituted so as to calculate the probability based on a time elapsed after the traffic congestion has occurred on the next lane.

Accordingly, another appropriate control of the cutting-into probability calculating device can be attained.

According to another preferred embodiment of the present invention, the cutting-into probability calculating device is constituted so as to calculate the probability based on a speed difference between the own vehicle's speed and a speed of the another vehicle traveling on the next lane.

Accordingly, another appropriate control of the cutting-into probability calculating device can be attained.

According to another preferred embodiment of the present invention, the cutting-into probability calculating device is constituted so as to calculate the probability based on a vehicle-to-vehicle distance between the own vehicle and a vehicle which travels on the same lane and in front of the own vehicle.

Accordingly, another appropriate control of the cutting-into probability calculating device can be attained.

Other features, aspects, and advantages of the present invention will become apparent from the following description which refers to the accompanying drawings.

### BRIEF DESCRIPTION OF THE DRAWINGS

FIG. 1 is a diagram showing a scene of a vehicle traveling on a highway at around an interchange according to an embodiment of the present invention.

FIG. 2 is a block diagram of a traveling control device of a vehicle.

FIG. 3 is a flowchart of control processing of the traveling control device of a vehicle.

FIG. 4 is a flowchart of control processing of the traveling control device of a vehicle.

FIG. 5 is a flowchart of control processing of the traveling control device of a vehicle.

### DETAILED DESCRIPTION OF THE INVENTION

Hereinafter, preferred embodiments of the present invention will be described referring to the accompanying drawings. It should be understood that even though embodiments are separately described, single features thereof may be combined to additional embodiments.

Embodiment 1

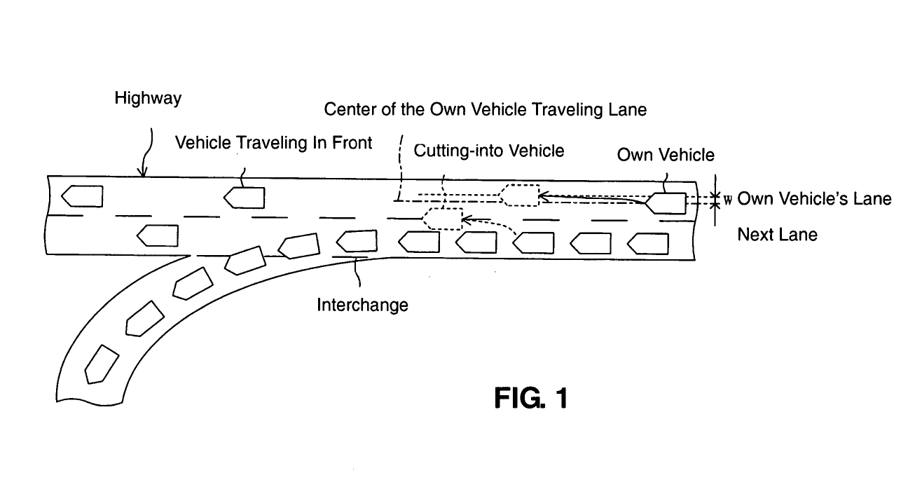

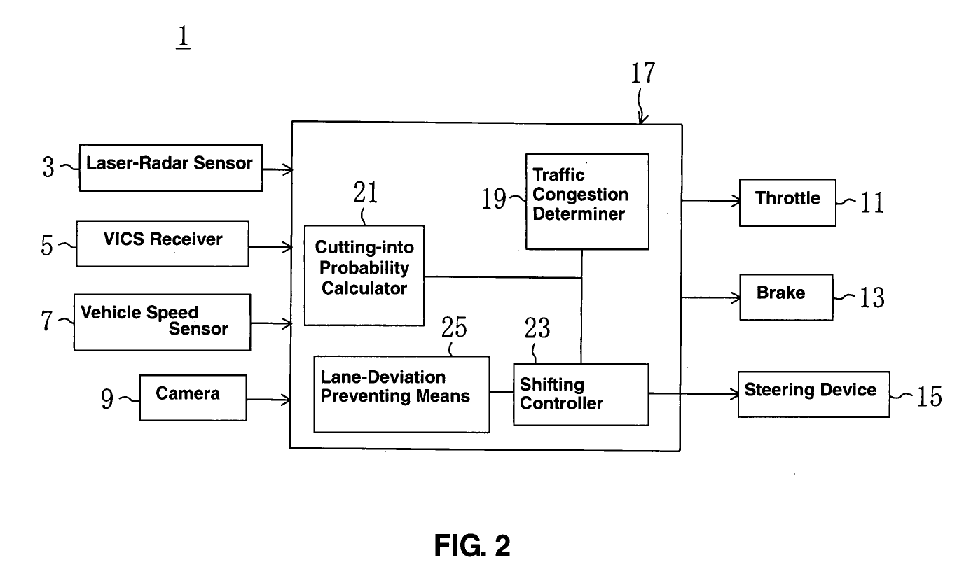

A traveling control device 1 according to a preferred embodiment of the present invention performs its appropriate control when a vehicle (hereinafter, referred to as “own vehicle”) travels on a specified lane of a highway having plural lanes, especially at around an interchange of the highway, as shown in FIG. 1 (the highway having two lanes in the same direction in the figure). As shown in FIGS. 1 and 2, the traveling control device 1 comprises a laser-radar sensor 3 operative to detect a vehicle-to-vehicle distance between the own vehicle and a vehicle traveling in front of the own vehicle, a relative speed between the own vehicle's speed and a vehicle speed of another vehicle traveling on a lane next to the own vehicle's traveling lane, a receiver 5 for VICS (the road traffic information communication system) to receive road-traffic information including a traffic congestion, a vehicle speed sensor 7 operative to detect the own vehicle's speed, a camera 9 operative to detect a traveling position of the own vehicle on the traveling lane by picking up an image around the own vehicle, a throttle 11, a brake 13, a steering device 15, and a controller 17 operative to perform some controls. The above-described vehicle traveling in front of the own vehicle means a vehicle which travels on the same lane and just in front of the own vehicle. The above-described lane next to the own vehicle's traveling lane means a lane which is adjacent to the traveling lane of the own vehicle. Herein, a vehicle speed control device corresponds to the throttle 11, the brake 13, and the controller 17, a traveling position detecting device corresponds to the camera 9, and a steering device corresponds to the steering device 15.

To an input side of the controller 17 are connected the laser-radar sensor 3, VICS receiver 5, vehicle speed sensor 7, camera 9 and the like, and to an output side thereof are connected the throttle 11, brake 13, steering device 15, and the like. The controller 17 performs the auto-cruising control in its mode which adjusts actuators of the throttle 11 and brake 13 or the like so as to control the own vehicle' speed at a target vehicle speed which has been set (hereinafter, referred to as “set speed”). The auto-cruising mode and the set speed are set, for example, by the driver with some specified operations. A specified vehicle speed according to the present invention corresponds to “the set speed”.

Further, the controller 17 comprises a traffic congestion determiner 19 operative to determine whether the traffic congestion occurs or not on the next lane, a cutting-into probability calculator 21 which calculates a probability (hereinafter, referred to as “cutting-into probability”) of another vehicle traveling on the next lane cutting into the traveling lane of the own vehicle when it is determined by the traffic congestion determiner 19 that the traffic congestion occurs on the next lane, a shifting controller 23 operative to shift the traveling position of the own vehicle toward an opposite side (the right side in FIG. 1) from the next lane by controlling the steering device 15 when the vehicle speed control device performs the vehicle speed control of the own vehicle and it is determined by the traffic congestion determiner 19 that the traffic congestion occurs on the next lane, and a lane-deviation preventing means 25 operative to prevent the own vehicle from deviating from the traveling lane of the own vehicle when the shifting controller 23 performs the shifting control of the own vehicle. Herein, a traffic congestion determining device according to the present invention corresponds to the traffic congestion determiner 19, a cutting-into probability calculating device according to the present invention corresponds to the cutting-into probability calculator 21, a shifting control device according to the present invention corresponds to the shifting controller 23, and a lane-deviation preventing device according to the present invention corresponds to the lane-deviation preventing means 25.

The traffic congestion determiner 19 determines whether or not the traffic congestion occurs based on the road traffic information and the like received from the VICS receiver 5.

The cutting-into probability calculator 21 calculates the cutting-into probability of the vehicle traveling on the next lane cutting into jut in front of the own vehicle based on a distance of the traffic congestion on the next lane, a time elapsed after the traffic congestion has occurred on the next lane, a speed difference between the own vehicle's speed and a peed of the another vehicle traveling on the next lane, and a vehicle-to-vehicle distance between the own vehicle and a vehicle which travels on the same lane and in front of the own vehicle. The above-described traffic congestion distance and time elapsed are considered parameters which are relevant to a mental state of a driver of the vehicle traveling on the next lane who may want to cut into to get out of the traffic congestion. The above-described speed difference and vehicle-to-vehicle distance are considered parameters which are relevant to the mental state of the driver of the vehicle traveling on the next lane who may decide a timing of the cutting-into. Also, the traffic congestion distance and time elapsed are obtained based on the road traffic information from the VICS receiver 5 and the like, the speed deference is obtained based on detecting results of the laser-radar sensor 3 and the vehicle speed sensor 7, and the vehicle-to-vehicle distance is obtained based on detecting results of the laser-radar sensor 3.

Specifically, the cutting-into probability calculator 21 calculates the cutting-into probability based on the following equation (1).
F=a·L+b·T+c·V+d·R (1)

Herein, F is the cutting-into probability, L is the traffic congestion distance, T is the time elapsed, V is the speed difference, R is the vehicle-to-vehicle distance. Also, a, b, c and d are constant values to satisfy relationships of a>b>c>d.

The shifting controller 23 controls the steering device 15 in such a manner that the traveling position of the own vehicle is sifted toward the opposite side (the right side in FIG. 1) from the next lane with respect to the current position based on the cutting-into probability calculated by the cutting-into probability calculator 21 when the auto-cruising control is performed and it is determined by the traffic congestion determiner 19 that the traffic congestion occurs on the next lane.

Further, the controller 17 controls the own vehicle such that the center position of the own vehicle can be located at a center tine of the traveling lane in the width direction.

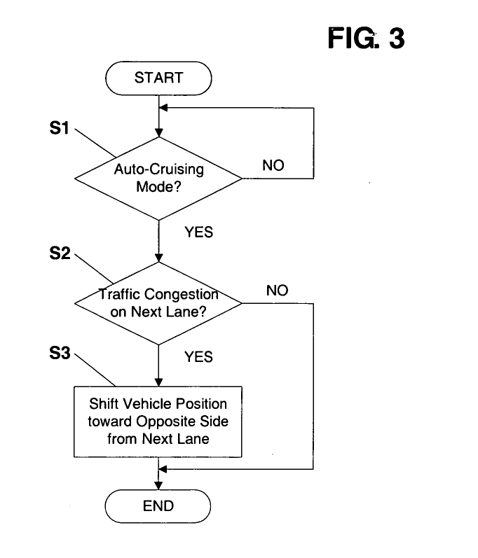

Hereinafter, the control processing of the traveling control device 1 will be described referring to FIG. 1 and a flowchart of FIG. 3. At first, in step S1, it is determined whether or not the own vehicle travels in the auto-cruising mode. When the answer to the step S1 is YES, the control sequence proceeds to step S2. When the answer is NO, the control sequence returns to start.

In the step S2, it is determined whether or not the traffic congestion occurs on the next lane. When the answer to the step S2 is YES, the control sequence proceeds to step S3, and when the answer is NO, it returns to the start.

In the step S3, the steering device 15 is controlled based on the cutting-into probability calculated such that the traveling position of the own vehicle can be sifted toward the opposite side from the next lane, i.e. the right. side on the lane. Thereby, the own vehicle will travel at a right-side shifted position with respect to the present traveling position at the constant speed. After the vehicle has passed the portion of traffic congestion portion of the next lane, the vehicle's traveling position is changed to an original position.

According to the present embodiment described above, since the shifting controller 23 performs the shifting control to shift the traveling position of the own vehicle toward the opposite side from the next lane when the controller 17 performs the auto-cruising control and it is determined by the traffic congestion determiner 19 that the traffic congestion occurs on the next lane, the own vehicle is kept away from the next lane. Thus, the crash against the cutting-into vehicle from the next lane can be properly avoided without operating the accelerator, brake 13, or steering handle, when the auto-cruising control is performed and the traffic congestion occurs on the next lane. Thereby, the safety of the own vehicle can be improved when the controller 17 performs the cruising control.

Generally, the probability of another vehicle traveling cutting into the own vehicle's traveling lane from the next lane with the traffic congestion is considered influenced by the driver's mental state.

According to the present embodiment, the cutting-into probability calculator 21 calculates the probability of another vehicle traveling on the next lane cutting into the own vehicle's traveling lane when it is determined by the traffic congestion determiner 19 that the traffic congestion occurs on the next lane, and the shifting controller 23 performs the shifting control based on the probability calculated by the cutting-into probability calculator 21 when the auto-cruising control is performed and it is determined by the traffic congestion determiner 19 that the traffic congestion occurs on the next lane. Accordingly, the shifting controller 23 can perform the shifting control which is suitable to the driver's mental state of the vehicle traveling on the next lane with the traffic congestion.

Also, since the lane-deviation preventing means 25 prevents the own vehicle from deviating from the traveling lane of the own vehicle when the shifting controller 23 performs the shifting control of the own vehicle by controlling the steering device 15, the deviation of the own vehicle from the traveling lane can be properly prevented when the shifting controller 23 performs the shifting control.

Embodiment 2

The present embodiment is different from the above-described embodiment 1 in a controlling manner of the shifting controller 23. Namely, as shown in FIG. 1, where the distance of the own vehicle's position from the center of the traveling lane is indicated as W, the shifting controller 23 performs the shifting control, for example, in such a manner that the center position of the own vehicle is shifted toward the opposite side from the next lane so as to be located at the position of W=300 mm when the cutting-into probability F is small, at the position of W=600 mm when the cutting-into probability F is middle, and at the position of W=900 mm when the cutting-into probability F is large (see FIG. 1). Herein, the range of the cutting-into probability F (i.e., small, middle and large) has been determined previously. The specific distance of W described above can be set properly.

Herein, when the auto-cruising control is performed, the traffic congestion occurs on the next lane and the own vehicle is traveling at the position further away from the next lane than a specified distance corresponding to the calculated cutting-into probability, the shifting controller 23 will not perform the shifting control.

The lane-deviation preventing means 25 sets an upper limit of the above-described distance W to prevent the own vehicle from deviating from the traveling lane of the own vehicle during the shifting control of the shifting controller 23.

Others are substantially the same as the embodiment 1.

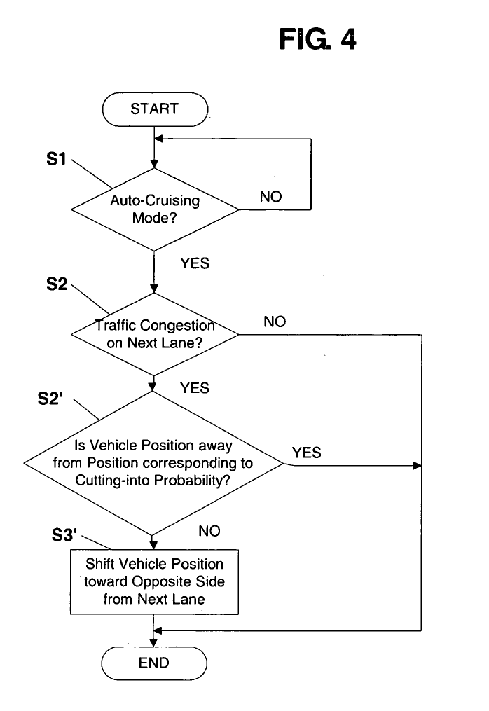

Hereinafter, the control processing of the traveling control device 1 will be described referring to FIG. 1 and a flowchart of FIG. 4. At first, in step S1, it is determined whether or not the own vehicle travels in the auto-cruising mode. When the answer to the step S1 is YES, the control sequence proceeds to step S2. When the answer is NO, the control sequence returns to start.

In the step S2, it is determined whether or not the traffic congestion occurs on the next lane. When the answer to the step S2 is YES, the control sequence proceeds to step S2′, and when the answer is NO, it returns to the start.

In the step S2′, it is determined whether or not the own vehicle's position is away from the specified position corresponding to the calculated cutting-into probability, toward the opposite side, i.e., the right side (for example, from the position of W=300 mm when the cutting-into probability F is small). When the answer to the step S2′ is NO, the control sequence proceeds to step S3′, and when the answer is YES, it returns to the start.

In the step S3′, the steering device 15 is controlled such that the own vehicle's traveling position is located at the specified position corresponding to the calculated cutting-into probability. Thereby, the own vehicle travels at the right-side shifted position at the constant speed. After the vehicle has passed the portion of traffic congestion portion of the next lane, the vehicle's traveling position is controlled to the original traveling position.

According to the present embodiment, the same function and effect as those of the embodiment 1 are obtained.

Embodiment 3

In the present embodiment, the controller 17 performs, not the auto-cruising control but the so-called following-traveling control. Namely, the controller 17 sets a target vehicle-to-vehicle distance between the own vehicle and the vehicle traveling in front of the own vehicle in the following-traveling mode, and the controller 17 adjusts the actuators of the throttle 11 and the brake 13 and the like in such a manner that the vehicle-to-vehicle distance between the own vehicle and the vehicle traveling in front is equal to the set target vehicle-to-vehicle distance. That is, the controller 17 adjusts the actuators of the throttle 11 and the brake 13 and the like in such a manner that the own vehicle's speed is equal to the same speed as the vehicle traveling in front of the own vehicle. For example, the controller 17 adjusts the actuators of the throttle 11 and the brake 13 and the like so that the own vehicle's speed is equal to 80 km/h when the following-traveling control is performed and the vehicle in front travels at the speed of 80 km/h. A following-traveling control mode is set, for example, by the driver with some specified operations. Others are substantially the same as the embodiment 1. The specified vehicle speed according to the present invention corresponds to the “the same speed as the vehicle traveling in front.”

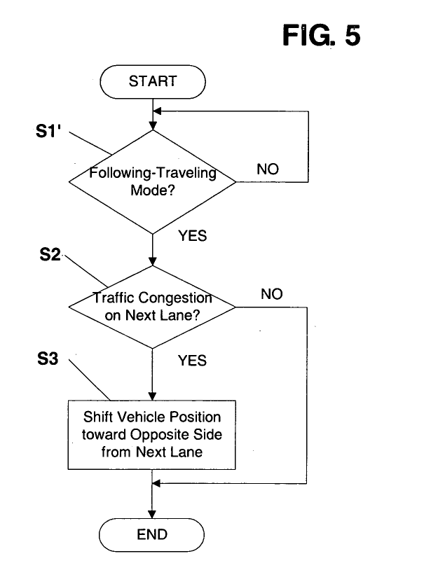

Hereinafter, the control processing of the traveling control device 1 will be described referring to FIG. 1 and a flowchart of FIG. 5. At first, in step S1′, it is determined whether or not the own vehicle travels in the following-traveling mode. When the answer to the step S1′ is YES, the control sequence proceeds to step S2. When the answer is NO, the control sequence returns to a start.

In the step S2, it is determined whether or not the traffic congestion occurs on the next lane. When the answer to the step S2 is YES, the control sequence proceeds to step S3, and when the answer is NO, it returns to the start.

In the step S3, the steering device 15 is controlled based on the calculated cutting-into probability such that the own vehicle's traveling position is shifted at the right side. Thereby, the own vehicle travels at the right-side shifted position at the same constant speed as the vehicle traveling in front of the own vehicle. After the vehicle has passed the portion of traffic congestion portion of the next lane, the vehicle's traveling position is controlled to the original traveling position.

According to the present embodiment, the same function and effect as those of the embodiment 1 are obtained.

Other Embodiments

Although the cutting-into probability is calculated based on the equation (1) in the respective embodiments described above, it may be obtained by different manners.

Also, although the cutting-into probability is calculated based on the above-described traffic congestion distance, elapsed time, vehicle speed difference, and vehicle-to-vehicle distance, it may be calculated based on at least one of them.

Further, although the shifting control is performed based on the cutting-into probability in the respective embodiments described above, for example, it may be controlled only when the cutting-into probability of the vehicle traveling on the next lane is higher than a specified probability.

Also, although the own vehicle's deviation from the traveling lane is prevented by setting the upper limit of the distance W during the shifting control by the shifting controller 23 in the respective embodiment described above (see the embodiment 2), other manners to prevent the vehicle deviation may be applied.

Also, the auto-cruising control or the following-traveling control are performed in the respective embodiments described above, these both controls may be performed at the same time.

The present invention should not be limited to the above-described embodiments and modified characteristics, but any other modifications and improvements may be applied within the scope of a sprit of the present invention.

What is claimed is:

1. A traveling control device of a vehicle, comprising:
a vehicle speed control device operative to control a vehicle speed of an own vehicle so as to be set at a specified vehicle speed;
a traveling position detecting device operative to detect a traveling position of the own vehicle on a traveling lane of the own vehicle;
a traffic congestion determining device operative to determine whether a traffic congestion occurs or not on a lane which is next to the traveling lane of the own vehicle; and
a shifting control device operative to shift the traveling position of the own vehicle toward an opposite side from the next lane when said vehicle speed control device performs the vehicle speed control of the own vehicle and it is determined by said traffic congestion determining device that the traffic congestion occurs on the next lane.

2. The traveling control device of a vehicle of claim 1, further comprising a cutting-into probability calculating device which calculates a probability of another vehicle traveling on the next lane cutting into the traveling lane of the own vehicle when it is determined by said traffic congestion determining device that the traffic congestion occurs on the next lane,
wherein said shifting control device is constituted so as to perform the shifting control based on the probability calculated by said cutting-into probability calculating device when said vehicle speed control device performs the vehicle speed control of the own vehicle and it is determined by said traffic congestion determining device that the traffic congestion occurs on the next lane.

3. The traveling control device of a vehicle of claim 1, wherein said shifting control device is constituted so as to perform the shifting control of the own vehicle by controlling a steering device when said vehicle speed control device performs the vehicle speed control of the own vehicle and it is determined by said traffic congestion determining device that the traffic congestion occurs on the next lane.

4. The traveling control device of a vehicle of claim 3, further comprising a lane-deviation preventing device operative to prevent the own vehicle from deviating from the traveling lane of the own vehicle when said shifting control device performs the shifting control of the own vehicle by controlling the steering device.

5. The traveling control device of a vehicle of claim 1, wherein said vehicle speed control device is constituted so as to control the own vehicle's speed at a target vehicle speed which is set as said specified vehicle speed.

6. The traveling control device of a vehicle of claim 1, wherein said vehicle speed control device is constituted so as to control the own vehicle's speed in such a manner that a vehicle-to-vehicle distance between the own vehicle and a vehicle which travels on the same lane and in front of the own vehicle is equal to a target vehicle-to-vehicle distance.

7. The traveling control device of a vehicle of claim 2, wherein said cutting-into probability calculating device is constituted so as to calculate the probability based on a distance of the traffic congestion on the next lane.

8. The traveling control device of a vehicle of claim 2, wherein said cutting-into probability calculating device is constituted so as to calculate the probability based on a time elapsed after the traffic congestion has occurred on the next lane.

9. The traveling control device of a vehicle of claim 2, wherein said cutting-into probability calculating device is constituted so as to calculate the probability based on a speed difference between the own vehicle's speed and a speed of the another vehicle traveling on the next lane.

10. The traveling control device of a vehicle of claim 2, wherein said cutting-into probability calculating device is constituted so as to calculate the probability based on a vehicle-to-vehicle distance between the own vehicle and a vehicle which travels on the same lane and in front of the own vehicle.
